(19) United States
(12) Patent Application Publication
(10) Pub. No.: US 2014/0317023 A1
(43) Pub. Date: Oct. 23, 2014

(54) STOCK INFORMATION PROVISION METHOD AND SYSTEM FOR DISPLAYING A BUSINESS GROWTH CYCLE AND CALCULATING UNDERVALUED/OVERVALUED STOCKS USING SAME

(71) Applicant: Sang Jung Kim, Seoul (KR)

(72) Inventor: Sang Jung Kim, Seoul (KR)

(21) Appl. No.: 14/360,080

(22) PCT Filed: Sep. 20, 2012
(86) PCT No.: PCT/KR2012/007513

§ 371 Date: May 22, 2014

(30) Foreign Application Priority Data
Dec. 2, 2011 (KR) 10-2011-0128374

(51) Int. Cl. G06Q 40/06

(52) U.S. Cl. CPC G06Q 40/06
USPC 705/36 R

(57) ABSTRACT

The present invention relates to stock information provision method and system for providing stock information and a business growth cycle as well, thereby helping investors select a buying or selling strategy according to each phase of the business growth cycle, and also presenting the degree by which the business is overvalued or undervalued in a percentage method. The stock information provision system includes a present value calculating unit which calculates a present value based on the latest net profits of the business, a normal value calculating unit which calculates a normal value based on net assets of the business, a future value calculating unit which calculates a future value based on a stock price of the business, and a business growth cycle calculating unit which decides one of phases forming a growth cycle of the business through comparison with the three values each other.

### TECHNICAL FIELD

The Present invention relates to stock information provision method and system, and more specifically to stock information provision method and system for calculating a business growth cycle, and then determining whether stocks of the business are undervalued or overvalued using the business growth cycle.

### BACKGROUND ART

Stock investment is one of financial techniques widely used among users. And, in order to invest in stock, the users have to figure out value of a stock, and then predict a rise or fall of the stock, and this is why securities firms provide different stock indicators used for the prediction.

Stock indicators widely used in stock investment are Price Earnings Ratio (PER) and Price Book-value Ratio (PBR). PER or PBR shows a ratio of a stock price to earnings or book-values, respectively, and thus a stock with a low PER or PBR is generally considered the one having a stock price lower than an enterprise value, that is, an undervalued stock. Accordingly, an undervalued stock is expected to rise, and thus a stock with a low PER or PBR has a merit for investment.

However, when considered from another point of view, PER or PBR may represent growth potential of an enterprise. That is, an enterprise with a high PER or PBR may be considered the one having high growth potential, and this indicates that the stock value of the enterprise will be increased greater in the future. Accordingly, a stock with a high PER or PBR may be considered the one having a merit for investment.

As described above, a stock with a low PER or PBR may be considered the one having an investment merit according to growth potential of an enterprise, or on the other hand the one without an investment merit. However, investors have difficulties in selecting a stock with an investment merit, because securities firms provide only information on stock indicators except for information on a business growth cycle and additional growth potential.

### DISCLOSURE

### Technical Problem

An objective of the present invention is to provide stock information provision method and system for providing business growth cycle and corresponding stock information together to allow users to determine whether the stock of the business is undervalued or overvalued.

### Technical Solution

The objective of the present invention is achieved by a stock information provision method including (a) calculating a present value based on the latest net profits of a business, normal value based on the latest net assets of the business, and a future value based on a stock price of the business, (b) deciding one of phases forming a business growth cycle of the business through comparison with the present, normal, and future values each other, and (c) providing the calculated business growth cycle.

Here, the present value is calculated in such a manner that the latest net profits of the business is divided by weighted average shares, the normal value is calculated in such a manner that Book-value Per Share (BPS) of the business is multiplied by a capitalization rate, and the future value is calculated in such a manner that the normal value of the business is multiplied by PBR.

In addition, the business growth cycle consists of six phases determined according to the following conditions: (i) future value>normal value>present value; (ii) future value>present value>normal value; (iii) present value>future value>normal value; (iv) present value>normal value>future value; (v) normal value>present value>future value; and (vi) normal value>future value>present value, wherein the six phases consists of a first phase satisfying the condition (i), a second phase satisfying the condition (ii), a third phase satisfying the condition a fourth phase satisfying the condition (iv), a fifth phase satisfying the condition (v), and a sixth phase satisfying the condition (vi).

Besides, the stock information provision method may further include (d) calculating average stock indicators of businesses in each of the phases according to the calculated business growth cycle, and (e) comparing stock indicators of a target business with average stock indicators of other businesses in the same phase as the target business to provide the compared value.

Here, in step (e), a stock value of the target business is determined to be overvalued in a case in which the stock indicators of the target business are greater than the average stock indicators of other businesses in the same phase as the target business, while a stock value of the target business is determined to be undervalued in a case in which the stock indicators of the target business are less than the average stock indicators of other businesses in the same phase as the target business, and then an undervaluation or overvaluation of the stock value of the target business is provided.

Here, the stock indicators may include either PER or PBR.

The objective of the present invention is achieved by a stock information provision system including a present value calculating unit which calculates a present value based on the latest net profits of the business, a normal value calculating unit which calculates a normal value based on the latest net assets of the business, a future value calculating unit which calculates a future value based on a stock price of the business, and a business growth cycle calculating unit which decides one of phases forming a growth cycle of the business through comparison with the present, normal, and future values each other.

Here, the present value calculating unit calculates a present value by dividing the latest net profits of the business by weighted average shares, the normal value calculating unit calculates a normal value by multiplying BPS of the business and a capitalization rate together, and the future value calculating unit calculates a future value by multiplying the normal value of the business and PSR together.

In addition, the business growth cycle calculating unit divides a growth cycle of a business into six phases according to the following conditions: (i) future value>normal value>present value; (ii) future value>present value>normal value; (iii) present value>future value>normal value; (iv) present value>normal value>future value; (v) normal value>present value>future value; and (vi) normal value>future value>present value, wherein the six phases consists of a first phase satisfying the condition (i), a second phase satisfying the condition (ii), a third phase satisfying the condition a fourth phase satisfying the condition (iv), a fifth phase satisfying the condition (v), and a sixth phase satisfying the condition (vi).

The stock information provision system of the present invention may further include a unit for calculating stock indicators in each phase which calculates average stock indicators of businesses in each of the phases according to the calculated business growth cycle, and a stock value analyzing unit which compares stock indicators of a target business with average stock indicators of other businesses in the same phase as the target business so as to provide the compared value.

Here, the stock value analyzing unit determines that the target business has overvalued stock value in a case in which the stock indicators of the target business are greater than the average stock indicators of other businesses in the same phase as the target business, while the target business has undervalued stock value in a case in which the stock indicators of the target business are less than the average stock indicator of other businesses in the same phase as the target business, and then provides an undervaluation or overvaluation of the stock value of the target business.

### Advantageous Effects

Stock information provision method and system for providing a business growth cycle and calculating undervalued/overvalued stocks help investors make a decision to buy or sell stocks. Specifically, the present invention has advantages as follows. Firstly, investors select one phase of a business growth cycle provided by the present invention to easily use a buying or selling strategy. This is because a business growth cycle consists of six phases, that is, a business acceleration phase including a first phase (introduction), a second phase (growth), and a third phase (maturity), a business slowdown phase including a fourth phase (decline) and a fifth phase (recession), and the last phase including a sixth phase (recovery) in which a new business model is uncertain to be successful, wherein the investors select businesses in the acceleration phase when using a buying strategy, while picking up businesses in the slowdown phase when using a selling strategy in order to maximize investment returns. Secondly, the investors use the system for providing undervalued/overvalued stock information according to the present invention to sell stocks with high overvaluation percentages and buy stocks with high undervaluation percentages, thereby maximizing investment returns.

### DESCRIPTION OF DRAWINGS

FIGS. 1 and 2 illustrate are functional block diagrams of a schematic configuration of a stock information provision system according to one embodiment of the present invention.

FIG. 3 is a table of relationships between present, normal, and future values according to a business growth cycle.

FIG. 4 illustrates a graph of a growth cycle of a target business in the stock information provision system according to one embodiment of the present invention in an exemplary view.

FIG. 5 illustrates average stock indicators of each phase stored in a stock indicator database in an exemplary view.

FIG. 6 illustrates a case in which the degree by which the target business is undervalued or overvalued is shown in the stock information provision system according to one embodiment of the present invention in an exemplary view.

### MODE FOR INVENTION

Exemplary embodiments now will be described more fully hereinafter with reference to the accompanying drawings, in which embodiments of the invention are shown. The present disclosure may, however, be embodied in many different forms and should not be construed as limited to the exemplary embodiments set forth herein. Rather, these exemplary embodiments are provided so that this disclosure is thorough, and will fully convey the scope of the invention to those skilled in the art, and the present invention is defined by the appended claims. Throughout the drawings and the detailed description, unless otherwise described, the same drawing reference numerals are understood to refer to the same elements.

Hereinafter, stock information provision method and system according to one embodiment of the present invention are described in detail with reference to the accompanying drawings.

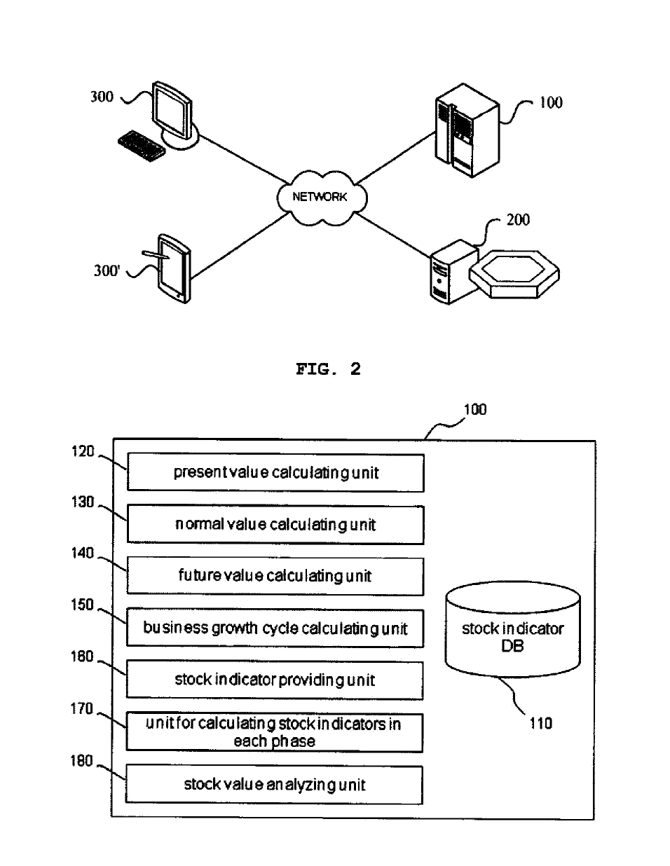

FIGS. 1 and 2 illustrate are functional block diagrams of a schematic configuration of a stock information provision system according to one embodiment of the present invention.

Referring to FIG. 1, a stock information provision system 100 according to one embodiment of the present invention receives stock information from a stock market system 200 and transmits the received stock information to client terminals 300 and 300′ through a network.

The stock information provision system 100 may provide a web page containing stock information of a target business according to a request from the client terminals 300 and 300′, and besides may provide functions of Home Trading System (HTS) to the client terminals 300 and 300′ to provide stock information a target business.

The client terminals 300 and 300′ include information processing devices for receiving stock information from the stock information provision system 100 through the network, wherein a Personal Computer (PC), a laptop computer, a Portable Digital Assistance (PDA), a smartphone, a tablet PC, and so on may be used for the terminals.

Referring to FIG. 2, the stock information provision system 100 according to one embodiment of the present invention includes a stock indicator database 110, a present value calculating unit 120, a normal value calculating unit 130, a future value calculating unit 140, a business growth cycle calculating unit 150, and a stock indicator providing unit 160.

The stock indicator database 110 stores stock indicators of a business, such as assets, net assets, the number of outstanding shares, net profits, Earnings Per Share (EPS), Return On Equity (ROE), stock price, PER, PBR, and so on. These stock indicators may be updated in the following manners: through corporate disclosures; and through a link connected with a stock market system in real time. For example, data such as assets, net assets, the number of outstanding shares, net profits, EPS, ROE, and so on may be provided from financial statements made public through corporate disclosures, and other data such as stock price, PER, PBR, and so on may be updated in real time through a link connected with a stock market system. In addition, EPS, ROE, PER, PBR, and so on may be calculated using data provided from corporate disclosures or a stock market system.

The present value calculating unit 120 uses data in the stock indicator database 110 to calculate a present value of a business. The present value is a stock indicator that is calculated on the basis of net profits on the latest financial statements of a business, and calculated in such indicators as EPS or ROE.

EPS is a value calculated in such a manner that net profits on the latest financial statements are divided by the number of outstanding shares, and more specifically calculated in such a manner that net profits on the financial statements of a business are divided by weighted average shares.

ROE is calculated in such a manner that EPS is divided by BPS, EPS is a value calculated in such a manner that net profits on financial statements are divided by the number of outstanding shares, and BPS is a value calculated in such a manner that net assets of a business are divided by the number of outstanding shares, and thus ROE is a value calculated in such a manner that net profits on financial statements are divided by net assets.

Although present value indicators such as EPS and ROE are widely used to help investors measure investment values of a business, EPS and ROE are calculated on the basis of the latest net profits of the business, thereby having an advantage that presents the current state of the business, while at the same time having a disadvantage that fails to present the future state of the business.

Accordingly, the present invention uses normal value and future value indicators to present a business growth cycle.

The normal value calculating unit 130 uses data in the stock indicator database 110 to calculate a normal value of a business. The normal value is a value indicator calculated on the basis of normal margins of a business, wherein the normal margins are a concept suggested by Ohlson and represent normal profits made by equity capital of the business. The normal margins may be calculated in such indicators as normal EPS or normal ROE.

The normal EPS is an indicator that represents profits per share expected to be normally made by a business, and calculated in such a manner that BPS is multiplied by normal ROE. The normal ROE is normal return rates expected to be made after the business invests equity capital, and may be calculated one-and-a-half times greater than interest of commercial banks. For example, assuming that interest of commercial banks are 4.0%, normal ROE may be 6.0% (0.06).

The future value calculating unit 140 uses data in the stock indicator database 110 to calculate a future value of a business. The future value is a value indicator calculated on the basis of net profits expected to be made by a business in the future, and may be calculated in such indicators as future EPS or future ROE. Here, the net profits expected to be made by a business in the future are calculated on the basis of a stock price of the business. Accordingly, future EPS is calculated in such a manner that normal EPS is multiplied by PBR. In addition, future ROE is calculated in such a manner that future EPS is divided by BPS.

For example, assuming that ΔΔ Soft Corporation has an EPS of 554.11, a BPS of 4,425, a PER of 17.65 times, and a PBR of 2.21 times, present, normal, and future values of the ΔΔ Soft Corporation may be 554.11 (EPS of the Corporation), 265.50, and 586.76, respectively.

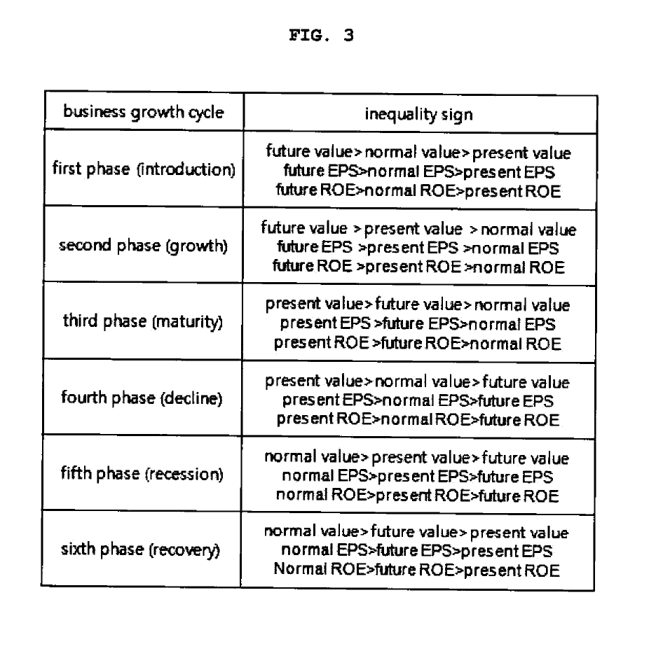

FIG. 3 is a table of relationships between present, normal, and future values according to a business growth cycle.

The business growth cycle calculating unit 150 compares the calculated present, normal, future values with each other to decide one of phases forming a business growth cycle. The business growth cycle consists of six phases, wherein the phases are a first phase (introduction) which is the beginning of a business, a second phase (growth) in which the business is continuously growing, a third phase (maturity) in which the business enter a stable growth phase, a fourth phase (decline) in which the growth of the business is reduced, a fifth phase (recession) in which the business is close to liquidation, and a sixth phase (recovery) in which the business tries a new business model.

The first phase (introduction) is a beginning stage of a business, wherein the business has an unstable business model, thereby making profits less than a normal amount of profits. However, because expected to grow, the business will earn more profits in the future. Accordingly, when the present, normal, and future values are formed in the following relationship: future value>normal value>present value, it is expected that the business is in the introduction phase.

The second phase (growth) is a stage in which a business model of the business begins entering a stable phase, wherein business risks against invested capital are reduced, profit rates are increased, and future profits are expected high. Accordingly, when the present, normal, and future values are formed in the following relationship: future value>present value>normal value, it is expected that the business is in the growth phase.

The third phase (maturity) is a stage in which the business model of the business is stabilized, wherein profitability reaches the highest level, and thus the present value becomes the highest one. However, in this phase, the future value begins falling. Accordingly, when the present, normal, and future values are formed in the following relationship: present value>future value>normal value, it is expected that the business is in the maturity phase.

The fourth phase (decline) is a stage in which the business model of the business begins decaying, wherein, in general, sales growth rates are decreased, profitability falls, and the future value is uncertainly expected. Accordingly, when the present, normal, and future values are formed in the following relationship: present value>normal value>future value, it is expected that the business is in the decline phase.

The fifth phase (recession) is a stage in which the business model is liquidated, wherein the business has currently low profitability and is expected to have low future profits. Accordingly, when the present, normal, and future values are formed in the following relationship: normal value>present value>future value, it is expected that the business is in the recession phase.

The sixth phase (recovery) is a stage in which the business tries a new business model, wherein business risks are high, and tangible as well as intangible assets are invested. Accordingly, when the present, normal, and future values are formed in the following relationship: normal value>future value>present value, it is expected that the business is in the recovery phase.

For example, because present, normal, and future values the ΔΔ Soft Corporation are 554.11, 265.50, and 586.76, respectively, the values are formed in the following relationship: future value>present value>normal value. Accordingly, the ΔΔ Soft Corporation is in the second phase (growth).

As described above, the business growth cycle calculating unit 150 uses present, future, and normal values to decide one of phases forming a business growth cycle.

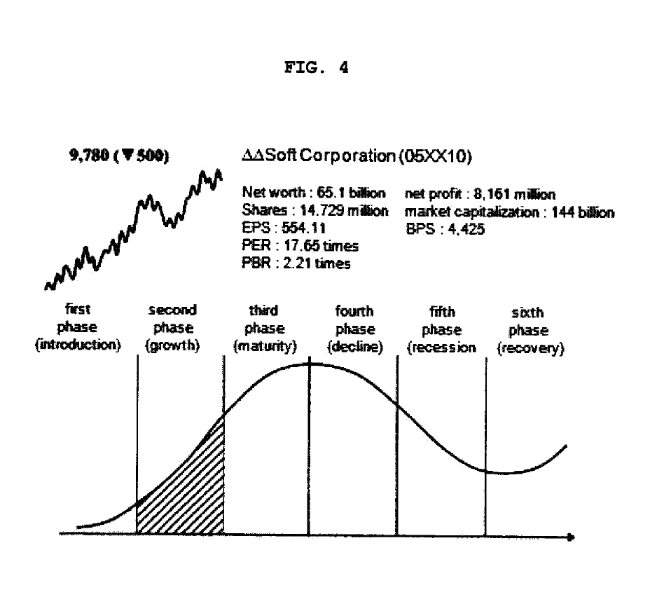

FIG. 4 illustrates a graph of a growth cycle of a target business in the stock information provision system according to one embodiment of the present invention in an exemplary view.

The stock indicator providing unit 160 receives the target business inputted in the client terminals to provide stock indicators on the target business as well as a growth cycle of the target business to the client terminals. For example, the stock indicator providing unit 160 may provide stock information on the ΔΔ Soft Corporation, as shown in FIG. 4. Referring to FIG. 4, the ΔΔ Soft Corporation is in the second phase (growth).

As described above, the stock indicator providing unit 160 provides stock indicators of the target business and graph of the business growth cycle calculated by the business growth cycle calculating unit 150 together, and thus investors easily appreciate which phase the target business is in.

Accordingly, investors considering a long term investment may select undervalued stocks in each of the phases or businesses in their favorite phases. In addition, when providing business consulting services, business consulting firms may refer to a business growth cycle, and then provide proper business consulting services according to the business growth cycle.

The stock information provision system 100 according to one embodiment of the present invention may further include a unit for calculating stock indicators in each phase and stock value analyzing unit.

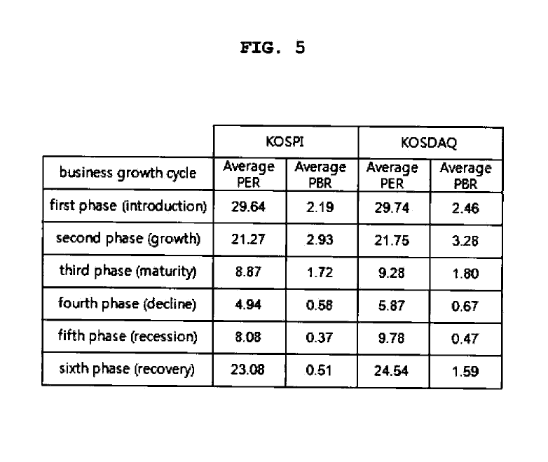

FIG. 5 illustrates average stock indicators of each phase stored in the stock indicator database 110 in an exemplary view.

Referring to FIG. 5, the unit for calculating stock indicators in each phase 170 calculates average stock indicators of businesses in each of the phases. The calculated average stock indicators in each of the phases are stored in the stock indicator database 110.

For example, the unit for calculating stock indicators in each phase 170 calculates average stock indicators of businesses in the first phase (introduction), average stock indicators of businesses in the second phase (growth), average stock indicators of businesses in the third phase (maturity), average stock indicators of businesses in the fourth phase (decline), average stock indicators of businesses in the fifth phase (recession), and average stock indicators of businesses in the sixth phase (recovery) among all the businesses listed on the Korea Composite Stock Price Index (KOSPI) and KOrea Securities Dealers Automated Quotations (KOSDAQ). Specifically, the unit for calculating stock indicators in each phase calculates PER and PBR of the businesses in each of the phases.

The stock value analyzing unit 180 compares average stock indicators of businesses in the same phase with each other according to a growth cycle of a target business, and then determines whether the target business is overvalued or undervalued.

Specifically, when a target business is inputted, the stock value analyzing unit 180 extracts a growth cycle of the target business calculated in the business growth cycle calculating unit 150. After that, the stock value analyzing unit 180 compares stock indicators of the target business with average stock indicators of other businesses in the same phase as the target business.

Especially, the stock value analyzing unit 180 may compare PER or PBR of the target business with average PER or PBR of other businesses in the same phase as the target business. PER or PBR is used to determine whether a stock is overvalued or undervalued, and thus the average PER or PBR of other businesses in the same phase as the target business is an essential element for valuating a stock value of the target business.

For example, when PBR or PER of the target business is greater than the average PER or PBR of other businesses in the same phase as the target business, it is determined that a stock price of the target business are overvalued.

Whereas, when PBR or PER of the target business is less than the average PER or PBR of other businesses in the same phase as the target business, it is determined that a stock price of the target business are undervalued.

Besides, the stock value analyzing unit may present the degree by which the target business is overvalued or undervalued using numerical figures. For example, a percentage method is used to show difference in value between PER or PBR of the target business and average PER or PBR of other businesses in the same phase as the target business, and thus the degree by which the target business is overvalued or undervalued may be shown in numerical figures.

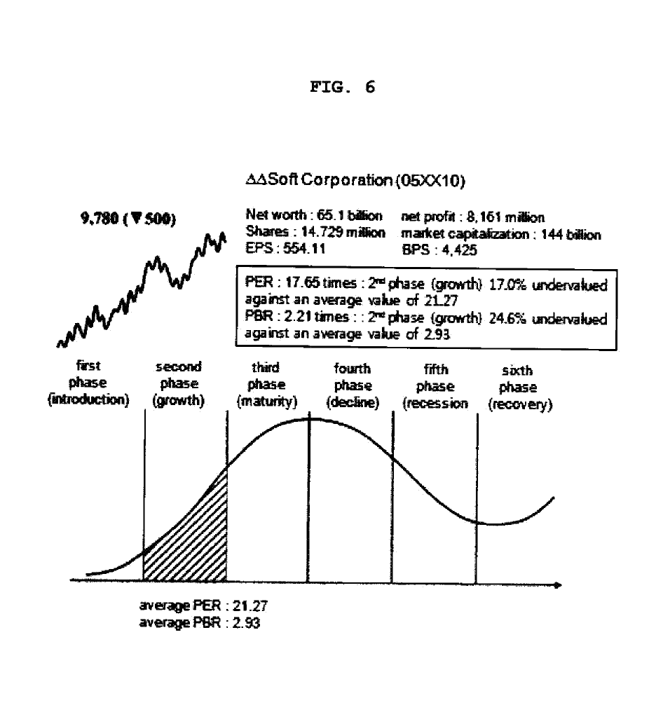

FIG. 6 illustrates a case in which the degree by which the target business is undervalued or overvalued is shown in the stock information provision system according to one embodiment of the present invention in an exemplary view.

Referring to FIG. 6, the stock information provision system according to one embodiment of the present invention provides stock indicators of the target business (ΔΔ Soft Corporation) and average PER and PBR of other businesses in the same phase as the target business (the second phase) together.

In FIG. 6, the ΔΔ Soft Corporation has a PER of 17.65 times, a PBR of 2.21 times, that is, high PER and PBR values. Accordingly, when a business growth cycle of the ΔΔ Soft Corporation is not considered, it may be determined that the ΔΔ Soft Corporation is overvalued.

However, the average PER of other businesses in the same phase as the target business (the second phase) is 21.27 times and the average PBR thereof is 2.93 times, that is, the average PER and PBR are greater than the PER and PBR of the ΔΔ Soft Corporation.

In addition, the stock information provision system according to one embodiment of the present invention compares stock indicators of the target business (ΔΔ Soft Corporation) with average PER and PBR of other businesses in the same phase as the target business (the second phase) together, so as to provide the degree by which the target business is overvalued or undervalued in numerical figures.

In FIG. 6, the ΔΔ Soft Corporation has a PER of 17.65 times, while an average PER of other businesses in the second phase (growth) is 21.27 times, and thus it may be determined that the ΔΔ Soft Corporation is undervalued as much as 17.0% based on PER (the valuation is calculated as follows: (17.65−21.27)/21.27=−0.170). In addition, the ΔΔ Soft Corporation has a PBR of 2.21 times, while an average PBR of other businesses in the second phase (growth) is 2.93 times, and thus it may be determined that the ΔΔ Soft Corporation is undervalued as much as 24.6% based on PBR (the valuation is calculated as follows: (2.21−2.93)/2.93=−0.246).

Accordingly, investors appreciate that the stock value of the ΔΔ Soft Corporation is less than other businesses in the same phase as the ΔΔ Soft Corporation, through an exemplary picture as shown in FIG. 6. Consequently, the stock value of the ΔΔ Soft Corporation is expected to rise regardless of high PER and PBR, and thus it is determined that the Corporation has a merit for investment.

As described above, the stock information provision system according to one embodiment of the present invention provides stock indicators of a target business and average stock indicators of other businesses in the same phase as the target business as well, thereby helping investors determine whether businesses are overvalued or undervalued.

It is apparent to those skilled in the art that the present invention may be embodied in different forms without changing the technical ideas or essential features thereof. Thus, the embodiment in the foregoing description is to be understood in an exemplary sense, not in a limited sense. The scope of the invention is not limited to the above-described embodiment, but is defined by the claims, and it is intended that the present invention cover the modifications and variations of this invention provided they come within the scope of the appended claims and their equivalents.

1. Stock information provision method performed by a stock information provision system, comprising:
calculating a present value based on the latest net profits of a business, wherein the present value is obtained by the stock information provision system in such a manner that the latest net profits are divided by weighted average shares or net assets of the business;
calculating a normal value based on net assets of the business, wherein the normal value is obtained by the stock information provision system in such a manner that a Book-value Per Share (BPS) of the business is multiplied by a capitalization rate, or interest of commercial banks are multiplied by a predetermined rate;
calculating a future value based on a stock price of the business, wherein the future value is obtained by the stock information provision system in such a manner that the normal value of the business is multiplied by Price Book-value Ratio (PBR);
comparing the present, normal, and future values with each other and deciding one of phases forming a business growth cycle of the business according to the compared results, wherein the stock information provision system decides that the business is in introduction, growth, maturity, decline, recession, and recovery phases when the present, normal, and future values are formed in such relationships as (i) future value>normal value>present value, (ii) future value>present value>normal value, (iii) present value>future value>normal value, (iv) present value>normal value>future value, (v) normal value>present value>future value, and (vi) normal value>future value>present value, respectively;
calculating average stock indicators of businesses in each of the phases according to the calculated business growth cycle; and
comparing stock indicators of a target business with average stock indicators of other businesses in the same phase as the target business, and then providing an undervaluation or overvaluation of the target business, wherein the stock information provision system determines that a stock value of the target business is overvalued in a case in which the stock indicators of the target business are greater than the average stock indicators of other businesses in the same phase as the target business, but undervalued in a case in which the stock indicators of the target business are less than the average stock indicators of other businesses in the same phase as the target business.

2. Stock information provision method according to claim 1, characterized in that the stock indicators comprise at least one of Price Earnings Ratio (PER) and PBR.

3. Stock information provision system, comprising:
a stock indicator database which stores stock indicators of a business, such as assets, net assets, the number of outstanding shares, net profits, Earnings Per Share (EPS), Return On Equity (ROE), stock price, PER, PBR, and so on;
a present value calculating unit which uses data in the stock indicator database to calculate a present value based on the latest net profits of the business, wherein the present value is obtained in such a manner that the latest net profits are divided by weighted average shares or net assets of the business;
a normal value calculating unit which uses data in the stock indicator database to calculate a normal value based on net assets of the business, wherein the normal value is obtained in such a manner that a BPS of the business is multiplied by a capitalization rate, or interest of commercial banks are multiplied by a predetermined rate;
a future value calculating unit which uses data in the stock indicator database 110 to calculate a future value based on a stock price of the business, wherein the future value is obtained in such a manner that the normal value of the business is multiplied by PBR;
a business growth cycle calculating unit which compares the calculated present, normal, future values with each other, and then decides one of phases forming a business growth cycle according to the compared results, wherein the business is determined to be in introduction, growth, maturity, decline, recession, and recovery phases when the present, normal, and future values are formed in such relationships as (i) future value>normal value>present value, (ii) future value>present value>normal value, (iii) present value>future value>normal value, (iv) present value>normal value>future value, (v) normal value>present value>future value, and (vi) normal value>future value>present value, respectively;
a unit for calculating stock indicators in each phase which calculates average stock indicators of businesses in each of the phases according to the phase decided by the business growth cycle calculating unit; and
a stock value analyzing unit which compares stock indicators of a target business with average stock indicators of other businesses in the same phase as the target business, and then providing an undervaluation or overvaluation of the target business, wherein a stock value of the target business is determined to be overvalued in a case in which the stock indicators of the target business are greater than the average stock indicators of other businesses in the same phase as the target business, but undervalued in a case in which the stock indicators of the target business are less than the average stock indicators of other businesses in the same phase as the target business.
